(19) United States
(12) Patent Application Publication
(10) Pub. No.: US 2021/0028660 A1
(43) Pub. Date: Jan. 28, 2021

(54) SUCTION MOTOR ASSEMBLY WITH MAGNETIC TRANSMISSION

(71) Applicant: SHARKNINJA OPERATING LLC, Needham, MA (US)

(72) Inventor: Alden KELSEY, Newton Upper Falls, MA (US)

(21) Appl. No.: 16/938,365

(22) Filed: Jul. 24, 2020

Related U.S. Application Data
(60) Provisional application No. 62/878,428, filed on Jul. 25, 2019.

(51) Int. Cl. H02K 1/27; H02K 7/14; A47L 9/22; A47L 5/22

(52) U.S. Cl. CPC H02K 1/27; A47L 5/22; A47L 9/22; H02K 7/14

(57) ABSTRACT

A suction motor assembly may include a motor, a suction body (e.g., an impeller such as an axial or radial impeller), and a magnetic transmission configured to transfer rotational motion from the motor to the suction body. A surface treatment apparatus may include a debris collector and a suction motor assembly. The suction motor assembly may include a motor, a suction body (e.g., an impeller such as an axial or radial impeller), and a magnetic transmission configured to transfer rotational motion from the motor to the suction body.

### CROSS-REFERENCE TO RELATED APPLICATIONS

The present application claims the benefit of U.S. Provisional Application Ser. No. 62/878,428 filed on Jul. 25, 2019, entitled Suction Motor Assembly with Magnetic Transmission, which is fully incorporated herein by reference.

### TECHNICAL FIELD

The present disclosure is generally directed to suction motors and more specifically to magnetic transmissions for a suction motor.

### BACKGROUND INFORMATION

Powered devices, such as vacuum cleaners, have multiple components that each receive electrical power from one or more power sources (e.g., one or more batteries or electrical mains). For example, a vacuum cleaner generally includes a suction motor assembly to generate a vacuum within a cleaning head. The suction motor assembly includes a motor and a suction body (e.g., an impeller such as an axial or radial impeller). The suction body can be directly coupled to a drive shaft of the motor such that the suction body rotates with the drive shaft. Rotation of the suction body causes a vacuum to be generated. The generated vacuum causes at least a portion of debris deposited on a surface to be cleaned to become entrained within an airflow extending into the vacuum cleaner such that at least a portion of the entrained debris can be deposited in, for example, a debris collector.

Universal motors are often used in powered devices, including vacuum cleaners. Consumers benefit from a cleaning device that has high suction, but are limited by the amount of power available to a motor using a household current or battery. Moreover, when a suction body is directly coupled to the motor, the speed of the suction body and the suction it generates is dictated by the speed of the motor.

A transmission between the motor and the suction body allows the two components to operate at differing speeds. However, mechanical transmissions operating at high speeds may not cost effective—both mechanical wear on transmission parts and the required precision in manufacturing may make use of a mechanical speed increase transmission impractical.

### BRIEF SUMMARY

An example of a suction motor assembly, consistent with the present disclosure, may include a motor, a suction body (e.g., an impeller such as an axial or radial impeller), and a magnetic transmission configured to transfer rotational motion from the motor to the suction body.

In some instances, the magnetic transmission may include a low speed rotor coupled to the motor and a high speed rotor coupled to the suction body. In some instances, the low speed rotor may include a plurality of low speed rotor magnets and the high speed rotor may include one or more high speed rotor magnets. In some instances, the magnetic transmission may further include a support structure having a plurality of ferromagnetic structures. In some instances, the ferromagnetic structures may be configured to modulate magnetic fields generated by the plurality of low speed rotor magnets. In some instances, the magnetic transmission may further include a stator. In some instances, the motor may be configured cause the low speed rotor to rotate at a first rotational speed and the low speed rotor and the high speed rotor are configured such that the high speed rotor rotates at second rotational speed, the second rotational speed measuring greater than the first rotational speed. In some instances, the low speed rotor may further include an aerodynamic element. In some instances, the low speed rotor and the high speed rotor may be counter rotating. In some instances, the high speed rotor may be one of a salient pole rotor or an inductive rotor.

An example of a surface treatment apparatus, consistent with the present disclosure, may include a debris collector and a suction motor assembly. The suction motor assembly may include a motor, a suction body (e.g., an impeller such as an axial or radial impeller), and a magnetic transmission configured to transfer rotational motion from the motor to the suction body.

In some instances, the magnetic transmission may include a low speed rotor coupled to the motor and a high speed rotor coupled to the suction body. In some instances, the low speed rotor may include a plurality of low speed rotor magnets and the high speed rotor may include one or more high speed rotor magnets. In some instances, the magnetic transmission may further include a support structure having a plurality of ferromagnetic structures. In some instances, the ferromagnetic structures may be configured to modulate magnetic fields generated by the plurality of low speed rotor magnets. In some instances, the magnetic transmission may further include a stator. In some instances, the motor may be configured cause the low speed rotor to rotate at a first rotational speed and the low speed rotor and the high speed rotor may be configured such that the high speed rotor rotates at second rotational speed, the second rotational speed measuring greater than the first rotational speed. In some instances, the low speed rotor may further include an aerodynamic element. In some instances, the low speed rotor and the high speed rotor may be counter rotating. In some instances, the high speed rotor may be one of a salient pole rotor or an inductive rotor.

### BRIEF DESCRIPTION OF THE DRAWINGS

These and other features and advantages will be better understood by reading the following detailed description, taken together with the drawings wherein:

FIG. 1A is a schematic block diagram of an example of a suction motor assembly, consistent with embodiments of the present disclosure.

FIG. 1B is a schematic block diagram of a transmission of the suction motor assembly of FIG. 1A, consistent with embodiments of the present disclosure.

FIG. 1C is a schematic example of a surface treatment apparatus, consistent with embodiments of the present disclosure.

FIG. 2A is a perspective view of a suction motor assembly, consistent with embodiments of the present disclosure.

FIG. 2B is an exploded side view of the suction motor assembly of FIG. 2A, consistent with embodiments of the present disclosure.

FIG. 2C is an exploded perspective view of the suction motor assembly of FIG. 2A, consistent with embodiments of the present disclosure.

FIG. 3 is a cross-sectional side view of the suction motor assembly of FIG. 2A, consistent with embodiments of the present disclosure.

FIG. 4 is a perspective view of the suction motor assembly of FIG. 2A, wherein portions of the suction motor assembly are removed to show magnetic rotors of a transmission of the suction motor assembly, consistent with embodiments of the present disclosure.

FIG. 5 is a top view of the magnetic rotors of FIG. 4, consistent with embodiments of the present disclosure.

FIG. 6A is a schematic top view of a magnetic transmission, consistent with embodiments of the present disclosure.

FIG. 6B is another schematic top view of the magnetic transmission of FIG. 6A, consistent with embodiments of the present disclosure.

FIG. 7 shows an example of a magnetic transmission and various examples of components capable of being used therewith, consistent with embodiments of the present disclosure.

FIG. 8 is a schematic example of a suction motor assembly having a magnetic transmission, consistent with embodiments of the present disclosure.

FIG. 9 is a schematic example of a magnetic transmission using an aerostatic bearing, consistent with embodiments of the present disclosure.

FIG. 10 is a cross-sectional side view of a suction motor assembly, consistent with embodiments of the present disclosure.

FIG. 11 is a perspective exploded view of the suction motor assembly of FIG. 10, consistent with embodiments of the present disclosure.

FIG. 12A is a perspective view of a magnetic transmission of the suction motor assembly of FIG. 10, consistent with embodiments of the present disclosure.

FIG. 12B is a perspective exploded view of the magnetic transmission of FIG. 12A, consistent with embodiments of the present disclosure.

### DETAILED DESCRIPTION

The present disclosure is generally directed to a suction motor assembly. The suction motor assembly may be configured to be used with a surface cleaning apparatus (e.g., a vacuum cleaner such as an upright vacuum cleaner, a handheld vacuum cleaner, a robotic vacuum cleaner, and/or any other surface cleaning apparatus). For example, in a surface cleaning apparatus, the suction motor assembly can be configured to generate a suction force at an inlet of the surface cleaning apparatus such that debris can be drawn into the inlet.

The suction motor assembly may include a motor, a suction body (e.g., an impeller such as an axial or radial impeller), and a magnetic transmission configured to transfer rotational motion from the motor to the suction body. Rotation of the suction body urges air to flow along an airflow path, wherein a portion of the airflow path extends through the suction motor assembly. Air flowing along the airflow path may have debris entrained therein. At least a portion of the entrained debris may be deposited in a debris collector of the surface cleaning apparatus before air flowing along the airflow path passes through the suction motor assembly.

A suction force generated by the suction motor assembly may be limited by the amount of power available to the motor using a household current or battery, and further by the speed of the suction body that is rotated by the motor.

Universal motors can be used in powered devices, including vacuum cleaners. Universal motors may reach peak efficiency around 40 thousand revolutions per minute (krpm) and may develop the most power at around 10-25 krpm. Efficiency of a suction body may increase as a size of the suction body is decreased and a rotational speed of the suction body is increased. For example, a reduction in the size of a suction body from a 110 millimeter (mm) diameter to a 65 mm diameter would increase efficiency; however, the rotational speed of the suction body may need to increase in order to optimally use the power available from the same motor. As such, in some instances, the suction body and the motor may have different rotational speeds. For example, for a 600-1200 Watt (W) universal motor operating at 10-25 krpm (e.g., as measured at a drive shaft of the motor), a 45 mm suction body may spin at approximately 100 krpm in order to optimize the efficiency of the suction body. To facilitate the different rotational speeds a transmission may be used to transfer rotational motion from the motor to the suction body, wherein the transmission is configured such that the suction body rotates faster than the motor. Mechanical transmissions operating at high speeds may not be cost effective—both mechanical wear on transmission parts and the required precision in manufacturing may make using a mechanical transmission impractical.

In an embodiment, the suction motor assembly includes a transmission incorporating a plurality of magnetic rotors. The suction motor assembly includes a motor and a suction body. A transmission transfers rotational motion from the motor to the suction body. The transmission includes a first and a second rotor. The first rotor is directly coupled to the motor (e.g., to a drive shaft of the motor). The second rotor is coupled to the suction body. Magnets are affixed to the first rotor such that the magnets rotate relative to (e.g., around) ferromagnetic structures fixed into a support structure. The ferromagnetic structures orient the magnetic fields that are generated by the magnets affixed to the first rotor as it rotates. The magnetic fields oriented by the ferromagnetic structures then interact with the second rotor. The interaction between magnets fixed in the second rotor and the magnetic fields transmitted by the ferromagnetic structures causes the second rotor to rotate around a rotation axis (e.g., a central axis) defined by the first rotor. The second rotor drives the rotation of the suction body. As such, the first and second rotors and ferromagnetic structures may generally be described as cooperating to form a magnetic transmission. A magnetic transmission allows torque generated by the motor to be transmitted from the first rotor to the second rotor without physical contact between the first and second rotors. The magnetic transmission can be constructed to be a speed increasing transmission such that the rotational speed of the suction body is greater than the rotational speed of the motor (e.g., as measured at a drive shaft of the motor).

In another embodiment, the suction motor assembly includes a transmission incorporating a plurality of rotors and a stator including magnetic elements. The suction motor assembly includes a motor and a suction body. A transmission is configured to transfer rotational motion from the motor to the suction body. The transmission includes a first rotor and a second rotor. The first rotor is directly coupled to the motor (e.g., to a drive shaft of the motor). The second rotor is coupled to the suction body. A fixed stator surrounds the first rotor, the fixed stator including a plurality of magnetic elements. Ferromagnetic structures are affixed to the first rotor such that as the first rotor is driven by the motor, they interact with magnets within the surrounding stator. The ferromagnetic structures orient the magnetic fields that are generated by the magnetic elements of the stator. The magnetic fields oriented by the ferromagnetic structures then interact with magnets of the second rotor. The interaction between magnets of the second rotor and the magnetic fields transmitted by the ferromagnetic structures causes the second rotor to rotate around a rotation axis (e.g., a central axis) defined by the first rotor. The second rotor drives the rotation of the suction body. As such, the first and second rotors and ferromagnetic structures may generally be described as cooperating to form a magnetic transmission. A magnetic transmission allows torque generated by the motor to be transmitted from the first rotor to the second rotor without physical contact between the first and second rotors. The magnetic transmission can be constructed to be a speed increasing transmission such that the rotational speed of the suction body is greater than the rotational speed of the motor (e.g., as measured at a drive shaft of the motor).

As used herein “first rotor,” “low speed rotor,” “primary rotor,” “input rotor”, or “drive rotor” refer to a rotor coupled (e.g., directly coupled) to the motor. As used herein “second rotor,” “high speed rotor,” “secondary rotor,” “output rotor”, or “driven rotor” refer to a rotor coupled (e.g., directly coupled) to the suction body. As used herein “irons,” “iron arcs,” or “iron pins” refer to any array of ferromagnetic structures used to transmit magnetism between at least two rotors.

Although specific embodiments of the suction motor assembly using radial flux are shown, other embodiments of the suction motor assembly using axial flux are within the scope of the present disclosure.

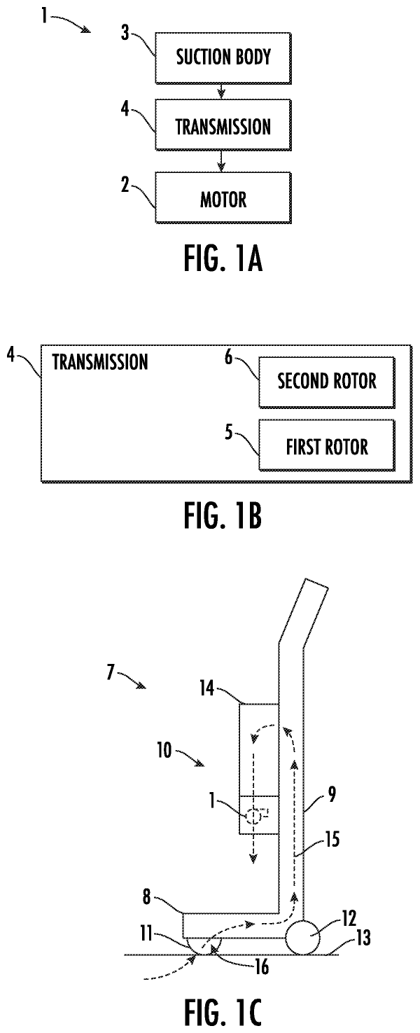

FIG. 1A shows a schematic block diagram of an example of a suction motor assembly 1. As shown, the suction motor assembly 1 includes a motor 2 and a suction body 3 (e.g., an impeller such as an axial or radial impeller). The motor 2 is configured to cause the suction body 3 to rotate. Rotation of the suction body 3 causes air to be urged into the suction motor assembly 1. The suction motor assembly 1 may further include a transmission 4 configured to transfer rotational motion from the motor 2 to the suction body 3. The transmission 4 can be configured such that a rotational speed and/or rotational direction of the motor 2 (e.g., a drive shaft of the motor 2) is different from a rotational speed and/or rotational direction of the suction body 3. For example, the transmission 4 can be configured such that a rotational speed of the suction body 3 measures greater than a rotational speed of the motor 2.

FIG. 1B shows a schematic block diagram of an example of the transmission 4. As shown, the transmission 4 includes a first rotor 5 and a second rotor 6. The first rotor 5 is coupled to the motor 2 and the second rotor 6 is coupled to the suction body 3. As such, the first rotor 5 and the second rotor 6 can be configured to cooperate such that a rotation of the first rotor 5 causes a rotation in the second rotor 6. In some instances, the first rotor 5 and the second rotor 6 can be configured to rotate at different rotational speeds. For example, the first rotor 5 and the second rotor 6 can be configured such that, in response to the first rotor 5 rotating 360° (a complete rotation), the second rotor 6 rotates more than 360°. As such, in this example, the second rotor 6 has a rotational speed that measures greater than the rotational speed of the first rotor 5.

The first rotor 5 and the second rotor 6 can be configured such that the transmission 4 is a non-contact transmission. A non-contact transmission may generally be described as a transmission in which rotational motion is transferred directly between at least a first component (e.g., the first rotor 5 or the second rotor 6) and a second component (e.g., the other of the first rotor 5 or the second rotor 6) without physical contact between the first and second components. For example, the first rotor 5 may be configured to transfer rotational motion to the second rotor 6 through the interaction between magnetic fields extending from the first rotor 5 and the second rotor 6. In this example, the transmission 4 may generally be referred to as a magnetic transmission.

FIG. 1C shows a schematic example of a surface treatment apparatus 7. As shown, the surface treatment apparatus 7 includes a surface cleaning head 8, an upright section 9 pivotally coupled to the surface cleaning head 8, and a vacuum assembly 10 coupled to the upright section 9. The surface cleaning head 8 includes one or more agitators 11 and at least one wheel 12 rotationally coupled thereto. The one or more agitators 11 are configured to rotate (e.g., in response to a rotation of an agitator motor). Rotation of the one or more agitators 11 may dislodge debris adhered to a surface to be cleaned 13.

The vacuum assembly 10 includes a debris collector 14 and the suction motor assembly 1 of FIG. 1A. The suction motor assembly 1 is configured to draw air along an airflow path 15. The airflow path 15 extends from an inlet 16 of the surface cleaning head 8 and through the debris collector 14 and the suction motor assembly 1. Air flowing along the airflow path 15 may have debris entrained therein. At least a portion of debris entrain within the air flowing along the airflow path 15 may be deposited in the debris collector 14. For example, the debris collector 14 may be configured to cause air flowing therethrough to have a cyclonic motion. The cyclonic motion may cause at least a portion of debris entrained within the air flowing along the airflow path 15 to be separated from the air. While the surface treatment apparatus 7 is shown as being an upright vacuum cleaner, the surface treatment apparatus 7 may be any type of surface treatment apparatus. For example, the surface treatment apparatus may be a handheld vacuum cleaner, a robotic vacuum cleaner, a canister vacuum cleaner, and/or any other surface treatment apparatus.

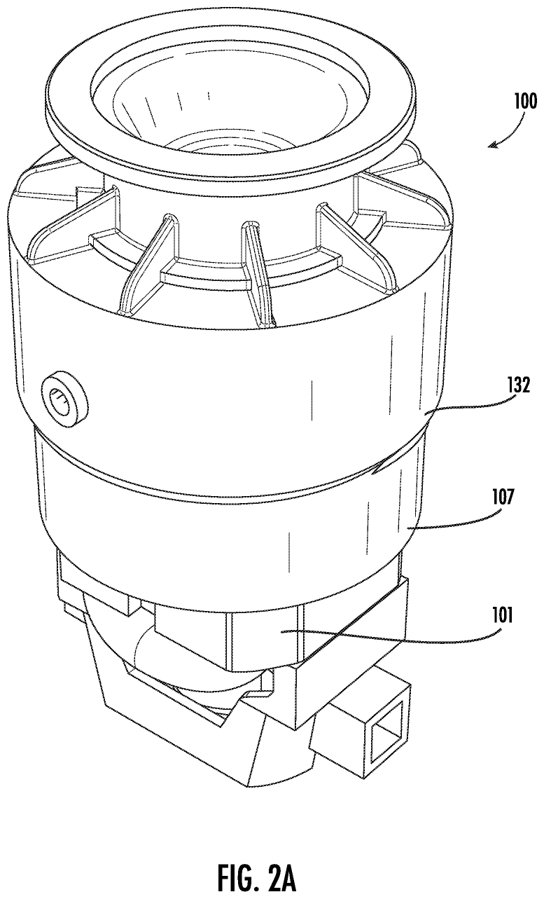

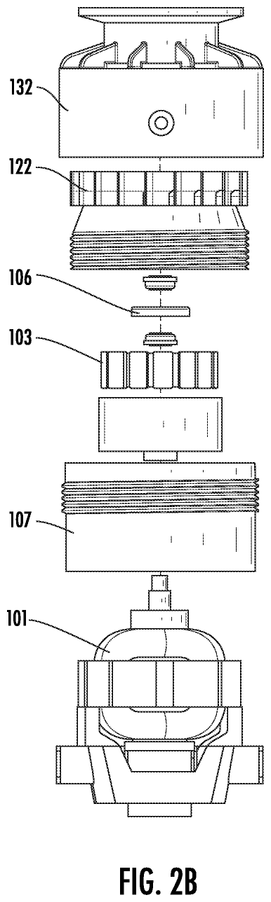

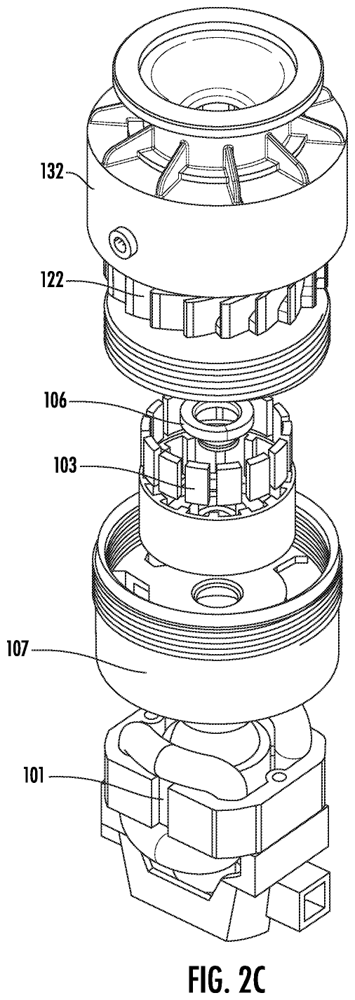

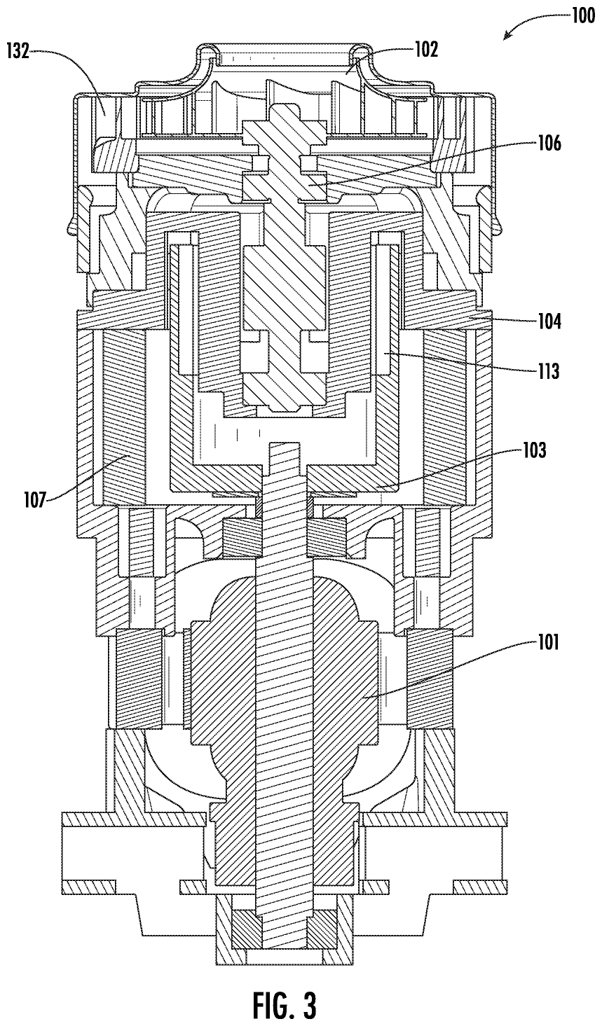

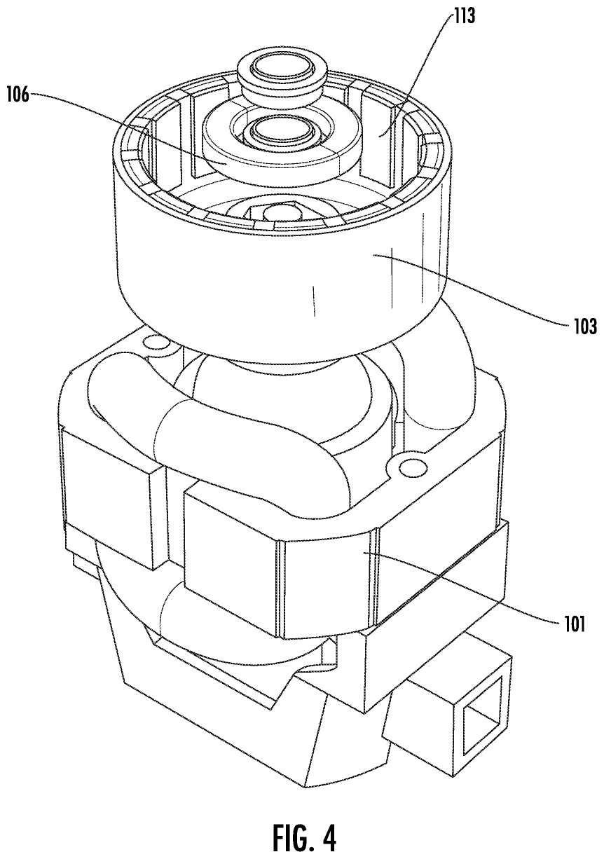

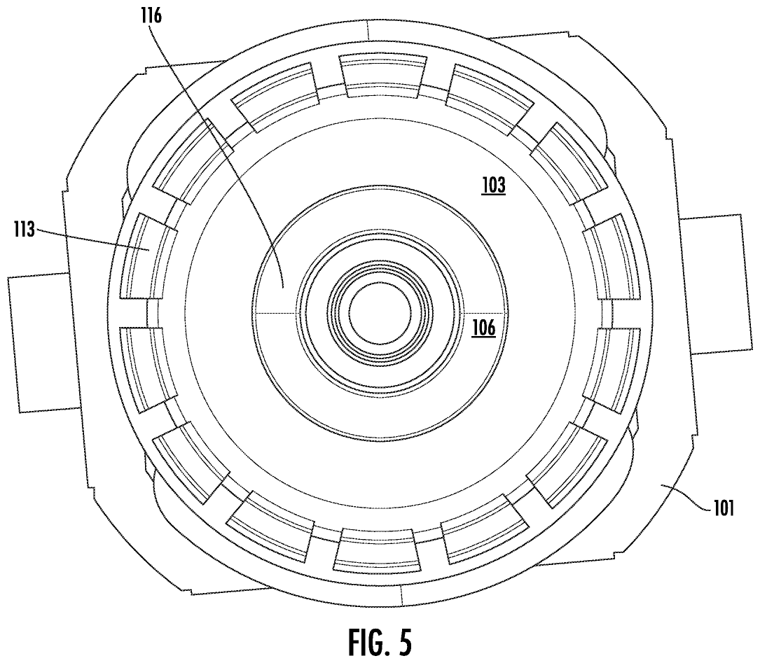

Referring to FIGS. 2A-5, a suction motor assembly 100, which may be an example of the suction motor assembly 1 of FIG. 1A, is shown. The suction motor assembly 100 includes a motor 101, a suction body housing 132, and a transmission housing 107. The suction body housing 132 further contains a suction body 102, a diffuser 122, and a high speed rotor 106. The high speed rotor 106 further contains one or more high speed rotor permanent magnets 116. The suction motor assembly 100 further includes a support structure 104 that includes a plurality of ferromagnetic structures (not shown). A low speed rotor 103 is coupled to the motor 101. The low speed rotor 103 includes a plurality of low speed rotor permanent magnets 113.

The motor 101 is configured to cause the low speed rotor 103 to rotate. For example, the low speed rotor 103 can be coupled to a drive shaft of the motor 101. The rotation of the low speed rotor 103 causes the low speed rotor permanent magnets 113 to rotate around the support structure 104. The ferromagnetic structures of the support structure 104 modulate the magnetic fields generated by the low speed rotor permanent magnets 113 and thereby transmit the magnetic forces to the high speed rotor permanent magnets 116. The interactions of the magnetic fields of the low speed rotor permanent magnets 113 and the high speed rotor permanent magnets 116 results in a magnetic coupling such that a rotation of the low speed rotor 103 causes the high speed rotor 106 to rotate at a rotational speed that measures greater than the rotational speed of the low speed rotor 103.

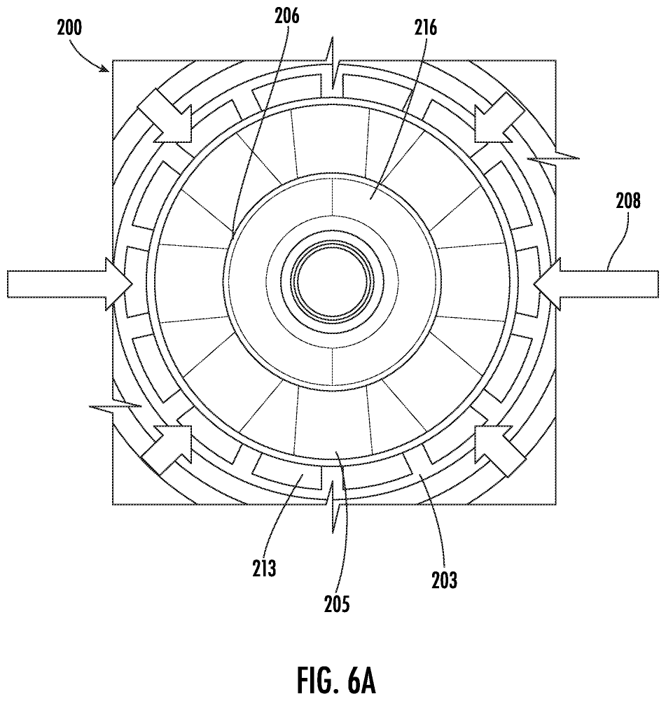

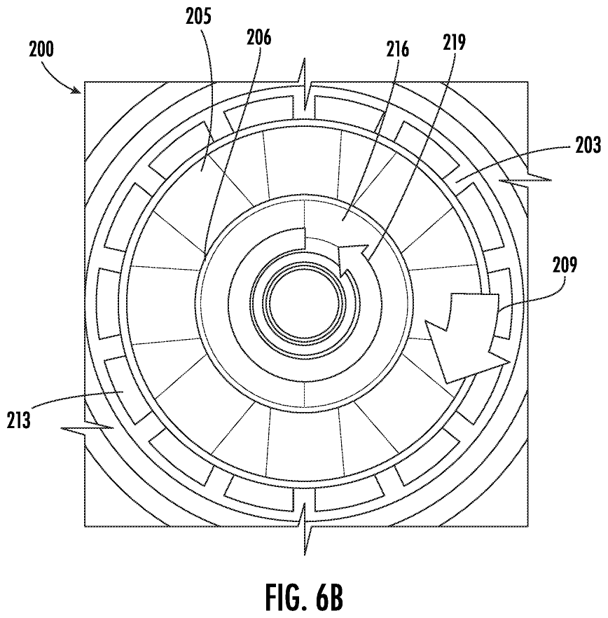

FIGS. 6A and 6B show an example of a magnetic transmission 200, which may be an example of the transmission 4 of FIG. 1A. As shown in FIGS. 6A and 6B, an asynchronous magnetic coupling is generated using low speed rotor permanent magnets 213. In the example embodiment, the low speed rotor 203 contains seven pairs of low speed rotor permanent magnets 213 arranged in a circle. With no torque being generated by a motor, the magnetic forces 208 generated by the low speed rotor 203 are balanced across the magnetic transmission. Eight ferromagnetic structures 205 interface with the seven pairs of low speed rotor permanent magnets 213 which operationally couples the seven pairs of low speed rotor permanent magnets 213 with the high speed rotor permanent magnets 216.

As shown in FIG. 6B, when the motor is turned on, the low speed rotor 203 rotates in a first rotation direction 209 about a rotation axis. The shifting magnetic fields are transmitted to the high speed rotor permanent magnets 216, causing the high speed rotor 206 to rotate in a second rotation direction 219 around the rotation axis. The high speed rotor 206 may be caused to be rotated at a different (e.g., faster) rotational speed than that of the low speed rotor 203. For example, one turn of the low speed rotor 203 may cause seven turns of the high speed rotor 206. In the described embodiment, the high speed rotor 206 rotates in the opposite direction as the low speed rotor 203. However, different configurations of ferromagnetic structures 205 and permanent magnets 213, 216, may enable the rotors 203, 206 to spin at asynchronous speeds in the same direction.

Although the magnetic transmission is shown as having seven pairs of low speed rotor permanent magnets 213 and eight ferromagnetic structures 205, different configurations may be used to transmit torque from a low speed rotor to a high speed rotor, thereby creating an asynchronous magnetic transmission.

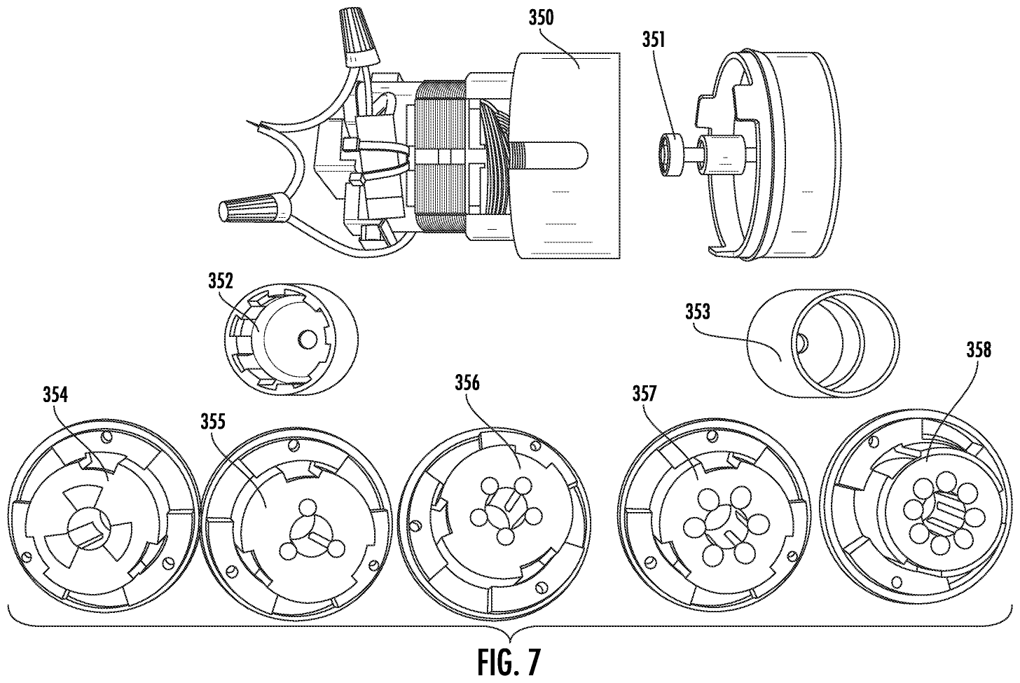

FIG. 7 includes non-limiting alternative embodiments for components of a magnetic transmission, which may be used in examples of the transmission 4 of FIG. 1A. A motor 350 is coupled to a primary rotor 352, 353. In various embodiments, the primary rotor 352 may include four pairs of permanent magnets and the primary rotor 353 may include seven pairs of permanent magnets. The primary rotor 352, 353 is configured to interface with a corresponding support structure 354, 355, 356, 357, 358. The support structures 354, 355, 356, 357, 358 are configured to receive a plurality ferromagnetic structures arranged in an array. The ferromagnetic structures may include pins, arcs, and/or any other ferromagnetic structures. For example, the support structure 354 includes three iron arcs, the support structure 355 includes three iron pins, the support structure 356 includes five iron pins, the support structure 357 includes six iron pins, and the support structure 358 includes eight iron pins. As shown, the ferromagnetic structures, are arranged around a central axis of a corresponding support structure 354, 355, 356, 357, 358. The support structures 354, 355, 356, 357, 358 are configured to magnetically couple a secondary rotor 351 to a corresponding primary rotor 352, 353, the secondary rotor 351 containing one pair of magnets.

Different permutations of primary rotors and iron pin arrays produce differing transmission ratios and rotational directions. The four pair primary rotor 352 paired with iron pin arrays including the support structure 354 having the three iron arcs or the support structure 355 having the three iron pins produces a 1:4 transmission ratio and a non-reversing transmission coupling. That is, for every turn of the primary rotor 352, 353, the secondary rotor 351 completes approximately four turns in the same direction as the primary rotor. The four pair primary rotor 352 paired with the support structure 356 having the five iron pin array produces a 1:4 transmission ratio and a reversing transmission coupling. The seven pair primary rotor 353 paired with the support structure 357 having the six iron pin array produces a 1:7 transmission ratio and a non-reversing transmission coupling. The seven pair primary rotor 353 paired with the support structure 358 having the eight iron pin array produces a 1:7 transmission ratio and a reversing transmission coupling. Permutations of the configurations may be used depending on the diameter of a suction body and the desired speed for the suction body.

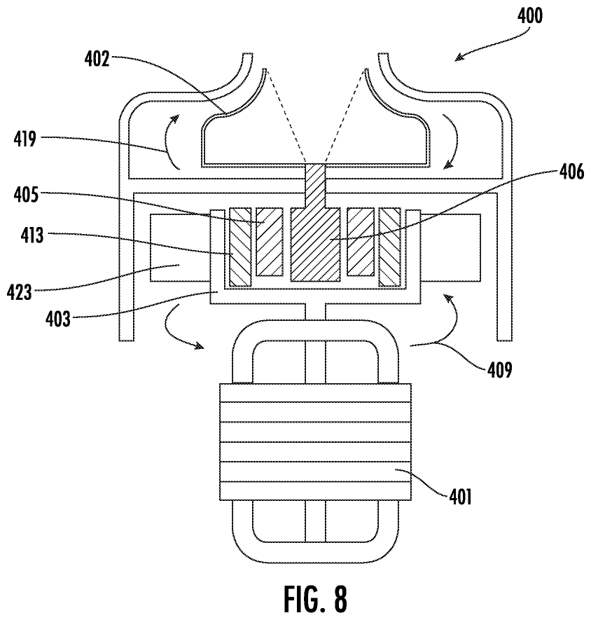

In addition to providing asynchronous speeds to increase efficiency, magnetic transmissions provide further benefits to a suction motor assembly. As shown in FIG. 8, a suction motor assembly 400 may include a motor 401, a suction body 402, and a magnetic transmission configured to transfer rotational motion from the motor 401 to the suction body 402. The suction motor assembly 400 may be an example of the suction motor assembly 1 of FIG. 1A. The motor 401 is coupled to the low speed rotor 403 such that the motor 401 causes the low speed rotor 403 to rotate. As the low speed rotor 403 rotates, it produces a first angular momentum in the direction described by arrow 409. The rotation of the low speed rotor 403 causes the low speed rotor permanent magnets 413 to rotate. Ferromagnetic structures 405 within a support structure (not shown) modulate the magnetic fields generated by the low speed rotor permanent magnets 413 such that rotation of the low speed rotor 403 causes a high speed rotor 406 to rotate. As the high speed rotor 406 rotates, it produces a second angular momentum in the direction described by arrow 419. The first angular momentum is in the opposite direction as the second angular momentum. Counter rotation of the low speed rotor 403 and high speed rotor 406 may minimize a gyroscopic effect created as a result of the rotation of the low speed rotor 403 and high speed rotor 406. In other words, counter rotation may, at least partially, cancel out the angular momentums generated as a result of the rotation of the low speed rotor 403 and the high speed rotor 406.

When motors are used in handheld or other consumer appliances, minimizing the gyroscopic effect generated, using the magnetic transmission, may improve the usability of a device. Specifically, it may reduce the amount of angular momentum felt by a user, thus potentially decreasing the effort required to stabilize the device while it is in use.

As further shown in FIG. 8, an aerodynamic element 423 may be coupled to the low speed rotor 403. The aerodynamic element 423 rotates in the direction described by arrow 409. As such, the aerodynamic element 423 is moving in the opposite direction as that of the suction body 402, which is coupled to the high speed rotor 406. The aerodynamic element 423 and the suction body 402 may be configured to cooperate (e.g., to increase the suction generated by the suction motor assembly 400). The difference in rotational velocity may increase the relative air speed within the suction motor assembly 400. In some instances, the aerodynamic element 423 may be configured mitigate the gyroscopic effect. The aerodynamic element 423 can be included in part of the transmission to form a multistage or adaptive air system.

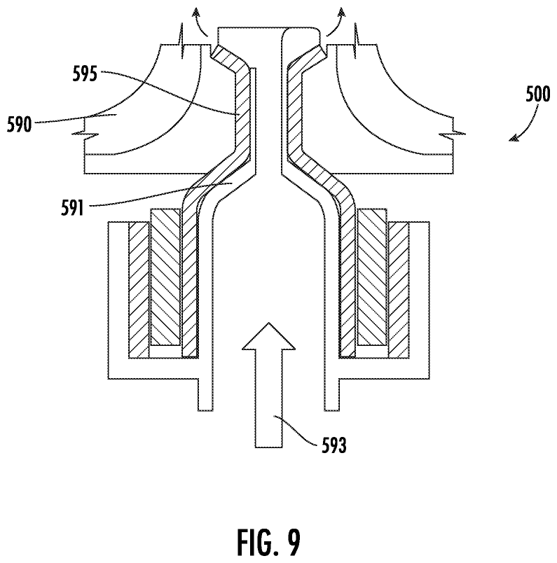

FIG. 9 shows a schematic example of a suction motor assembly 500, which may be an example of the suction motor assembly 1 of FIG. 1A. The suction motor assembly 500 couples a motor to a suction body using a magnetic transmission. A high speed rotor 590 may be supported by an aerostatic bearing 595 coupled to an extension of the low speed rotor shaft 591. In operation, the low speed rotor shaft 591 may be linked to a high pressure source. The high pressure source feeds air 593 through the rotor shaft 591 to directly feed the aerostatic bearing 595.

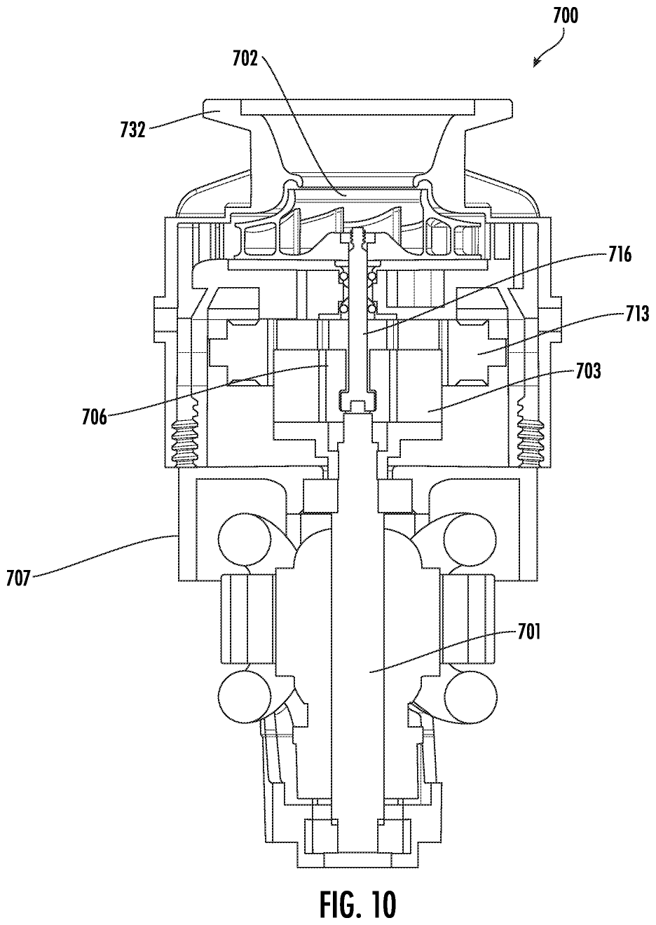

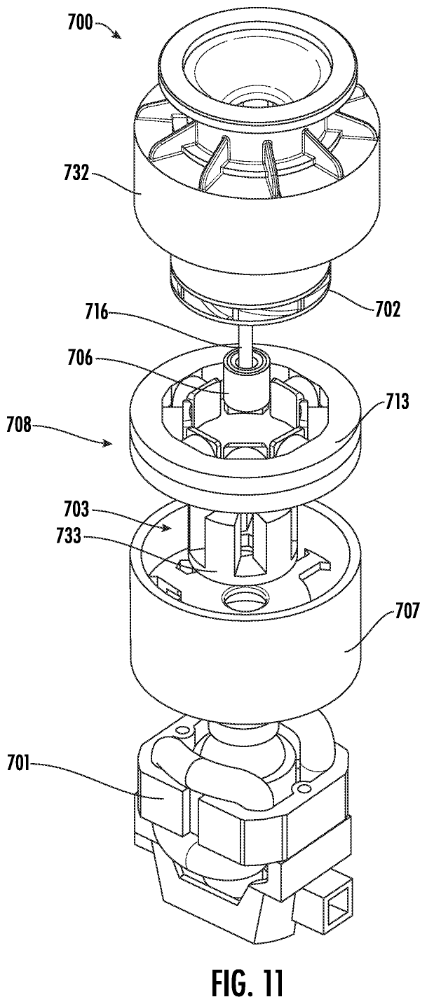

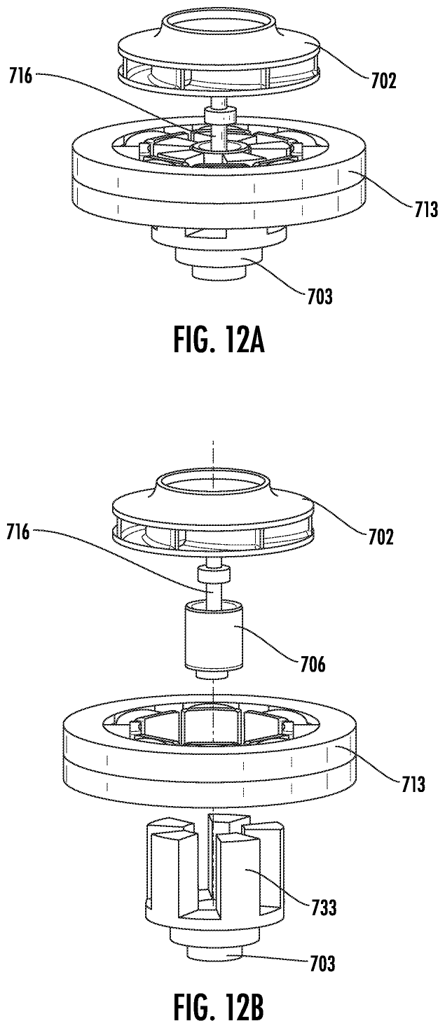

FIGS. 10-12B show an example of a suction motor assembly 700, which may be an example of the suction motor assembly 1 of FIG. 1A. The suction motor assembly 700 includes a motor 701, a suction body housing 732, and a transmission housing 707. The transmission housing 707 at least partially encloses a magnetic transmission 708. The suction body housing 732 further contains a suction body 702, a diffuser (not shown), and a high speed rotor 706. The high speed rotor 706 is coupled to a drive shaft 716 that connects to the suction body 702. A low speed rotor 703 is coupled to the motor 701. The low speed rotor 703 may be formed from a ferromagnetic material such as iron, wherein the low speed rotor 703 defines one or more ferromagnetic structures 733 that extend from a base of the low speed rotor 703. As shown, the low speed rotor defines a plurality of ferromagnetic structures 733, wherein the ferromagnetic structures 733 are spaced apart from each other. In some instances, the low speed rotor 703 may include a support structure and one or more ferromagnetic structures 733, such as pins or bars that form temporary magnets, disposed within the support structure. In this instance, the support structure may be made of a non-ferromagnetic material. A stator 713 surrounds the low speed rotor 703. The stator 713 may be formed using a plurality of electromagnets. In some instances, the stator 713 may be formed using permanent magnets.

The magnetic transmission 708 shown provides for the fixed field of the stator 713 and uses the low speed rotor 703 as a transmitting element to the high speed rotor 706. Rotation of the motor 701 causes rotation of the low speed rotor 703. During operation of the motor 701, the plurality of electromagnets of the stator 713 are powered and generate a magnetic field. The rotation of the low speed rotor 703 causes the low speed rotor 703 to rotate within the stator 713. The ferromagnetic structures 733 of the low speed rotor 703 modulate the magnetic fields generated by the plurality of electromagnets within the stator 713 and thereby transmit the magnetic forces to the high speed rotor 706. The high speed rotor 706 may be formed using one or more permanent magnets, using a salient pole rotor, or by using an inductive rotor. The transmission of magnetic force from the plurality of electromagnets within the stator 713 to the high speed rotor 706 using the low speed rotor 703 produces an asynchronous magnetic coupling, allowing for the transfer of torque and causing the high speed rotor 706 to rotate at a different (e.g., greater) speed than the low speed rotor 703.

As described above, the high speed rotor 706 may be formed using one or more permanent magnets, using a salient pole rotor, or by using an inductive rotor. A magnetic transmission that uses one or more permanent magnets in the high speed rotor 706 would allow the highest efficiency and torque transmission. However, permanent magnets can be expensive and can be brittle. A salient pole rotor (asymmetrical iron that follows the field's rotation because it serves as a bridge for the field) would have reduced efficiency, but still provide the desired increased speed transmission at a lower cost than the permanent magnets. An inductive rotor, such as a squirrel cage, may be used as the high speed rotor. The inductive rotor would have reduced efficiency as compared to the permanent magnets, but would prevent decoupling between the low speed rotor 703 and the high speed rotor 706.

The term “coupled” as used herein refers to any connection, coupling, link or the like by which torque input by one system element is imparted to the “coupled” element. Such “coupled” devices, may be, but are not necessarily directly connected to one another and may be separated by intermediate components or devices that may manipulate or modify such coupled elements. Likewise, the terms “connected” or “coupled” as used herein in regard to mechanical or physical connections or couplings is a relative term and may include, but does not require, a direct physical connection.

Elements, components, modules, and/or parts thereof that are described and/or otherwise portrayed through the figures to communicate with, be associated with, and/or be based on, something else, may be understood to so communicate, be associated with, and/or be based on in a direct and/or indirect manner, unless otherwise stipulated herein.

Unless otherwise stated, use of the word “substantially” or “approximately” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. It will be appreciated by a person skilled in the art that a surface cleaning apparatus may embody any one or more of the features contained herein and that the features may be used in any particular combination or sub-combination. Modifications and substitutions by one of ordinary skill in the art are considered to be within the scope of the present invention.

What is claimed is:

1. A suction motor assembly comprising:
a motor;
a suction body; and
a magnetic transmission configured to transfer rotational motion from the motor to the suction body.

2. The suction motor assembly of claim 1, wherein the magnetic transmission includes a low speed rotor coupled to the motor and a high speed rotor coupled to the suction body.

3. The suction motor assembly of claim 2, wherein the low speed rotor includes a plurality of low speed rotor magnets and the high speed rotor includes one or more high speed rotor magnets.

4. The suction motor assembly of claim 3, wherein the magnetic transmission further includes a support structure having a plurality of ferromagnetic structures.

5. The suction motor assembly of claim 4, wherein the ferromagnetic structures are configured to modulate magnetic fields generated by the plurality of low speed rotor magnets.

6. The suction motor assembly of claim 3, wherein the magnetic transmission further includes a stator.

7. The suction motor assembly of claim 2, wherein the motor is configured cause the low speed rotor to rotate at a first rotational speed and the low speed rotor and the high speed rotor are configured such that the high speed rotor rotates at second rotational speed, the second rotational speed measuring greater than the first rotational speed.

8. The suction motor assembly of claim 2, wherein the low speed rotor further includes an aerodynamic element.

9. The suction motor assembly of claim 2, wherein the low speed rotor and the high speed rotor are counter rotating.

10. The suction motor assembly of claim 2, wherein the high speed rotor is one of a salient pole rotor or an inductive rotor.

11. A surface treatment apparatus comprising:
a debris collector; and
a suction motor assembly, the suction motor assembly including:
a motor;
a suction body; and
a magnetic transmission configured to transfer rotational motion from the motor to the suction body.

12. The surface treatment apparatus of claim 11, wherein the magnetic transmission includes a low speed rotor coupled to the motor and a high speed rotor coupled to the suction body.

13. The surface treatment apparatus of claim 12, wherein the low speed rotor includes a plurality of low speed rotor magnets and the high speed rotor includes one or more high speed rotor magnets.

14. The surface treatment apparatus of claim 13, wherein the magnetic transmission further includes a support structure having a plurality of ferromagnetic structures.

15. The surface treatment apparatus of claim 14, wherein the ferromagnetic structures are configured to modulate magnetic fields generated by the plurality of low speed rotor magnets.

16. The surface treatment apparatus of claim 13, wherein the magnetic transmission further includes a stator.

17. The surface treatment apparatus of claim 12, wherein the motor is configured cause the low speed rotor to rotate at a first rotational speed and the low speed rotor and the high speed rotor are configured such that the high speed rotor rotates at second rotational speed, the second rotational speed measuring greater than the first rotational speed.

18. The surface treatment apparatus of claim 12, wherein the low speed rotor further includes an aerodynamic element.

19. The surface treatment apparatus of claim 12, wherein the low speed rotor and the high speed rotor are counter rotating.

20. The surface treatment apparatus of claim 12, wherein the high speed rotor is one of a salient pole rotor or an inductive rotor.
